(19) United States
(12) Patent Application Publication
(10) Pub. No.: US 2018/0103678 A1
(43) Pub. Date: Apr. 19, 2018

(54) Methods and Apparatus for Shape-Changing Food

(71) Applicants: Massachusetts Institute of Technology, Cambridge, MA (US); Syracuse University, Syracuse, NY (US)

(72) Inventors: Wen Wang, Singapore (SG); Lining Yao, Pittsburgh, PA (US); Chin-Yi Cheng, San Francisco, CA (US); Teng Zhang, Syracuse, NY (US); Hiroshi Ishii, Cambridge, MA (US); Daniel Wang, Cambridge, MA (US); Daniel Levine, Cambridge, MA (US)

(21) Appl. No.: 15/787,639

(22) Filed: Oct. 18, 2017

Related U.S. Application Data
(60) Provisional application No. 62/410,277, filed on Oct. 19, 2016.

(51) Int. Cl. A23P 20/20

(52) U.S. Cl. CPC A23P 20/20

(57) ABSTRACT

An edible structure may comprise a gelatin film and fiber strips. The gelatin film may have a higher density of gelatin in a first layer of the film than in a second layer of the film. The fiber strips may be attached to the first layer, and may have an initial orientation, thickness and density. The structure may be configured to undergo a shape transformation when the apparatus hydrates. During the transformation, the film may transform from a flat film into a curved, 3D film. Which specific shape results from the transformation may depend, at least in part, on the initial orientation, thickness and density of the fiber strips. The film may include flavorings or other additives. In some cases, the transformation may change a texture of the structure. In some cases, the transformation may be caused, at least in part, by a change in temperature.

### RELATED APPLICATIONS

This application claims the benefit of U.S. Provisional Application No. 62/410,277, filed Oct. 19, 2016 (the “Provisional Application”), the entire disclosure of which is herein incorporated by reference.

### FIELD OF TECHNOLOGY

The present invention relates generally to shape-changing food.

### SUMMARY

In illustrative implementations of this invention, an edible, shape-transforming structure comprises gelatin-fiber composite materials. This structure may change in shape from an edible flat film when dry, to curved 3D food when cooked with water. The flat food may be packaged without air, to save shipping cost and storage space.

In illustrative implementations, the flat food comprises: (a) a multi-layered gelatin film in which the volumetric mass density of gelatin varies in different layers of the film, and (b) fiber strips are on top of the gelatin film. Many features of the shape-transforming food may be controlled, including: (a) fragmentation, if any, during cooking, (b) shape and texture after the shape transformation, and (c) interaction with other food materials (e.g., whether the gelatin film wraps around other food during the shape transformation).

In some cases, the shape transformation is triggered by immersing the food in water, which in turn causes the food to swell as it absorbs water. For example, the food may comprise a gelatin film and swell as it becomes increasingly hydrated.

In some implementations, the shape transformation is temperature-dependent or is triggered by a change in temperature.

In some implementations, a computer may, via a UI (user interface) interact with a user, in such a way that: (a) the computer accepts input from a user, which input selects a target curved 3D shape with adjustable parameters; (b) based on the user's input, the computer simulates a shape transformation that will occur and causes the UI to display a preview of the simulated shape transformation; (c) the computer accepts input from a user that approves or disapproves of the previewed transformation; and (d) the computer outputs print instructions (e.g. G-codes for a 3D printer) that cause a printer to deposit one or more materials (e.g., edible fiber strips) of the flat edible food. In some cases, a machine-readable, non-transitory medium has instructions encoded thereon for enabling a computer to perform the computer functions described in the preceding sentence.

In some implementations of this invention, a flat, edible film that comprises gelatin and cellulose transforms into curved 3D food during cooking. This transformation process may be triggered by water absorption. In some cases, the flat, edible film undergoes 2D-to-3D folding, hydration-induced wrapping, or temperature-induced self-fragmentation.

In some implementations, a film comprises gelatin and fiber strips. In addition, the film may include flavors or additives. A wide variety of gelatin, fiber strips, flavors or additives may be employed, depending on the particular implementation. For example, in some cases: (a) gelatin with different molecular weights, or different levels of purity, or from different sources, may be employed; (b) the fiber strips may comprise cellulose or edible fibers from other sources; (c) the flavors may comprise fruit punch, vegetable extract, smashed fish or meat extract; and (d) the additives may comprise food dye or an active functional reagent.

In some cases, the gelatin has a non-homogenous distribution of volumetric mass density. In some cases, the fiber strips are printed on the film by a 3D printer or other CNC printer.

In some cases, the shape transformation comprises one or more of the following: bending, wrapping, twisting, folding, chopping, deforming, disrupting and dissolving.

In some cases, a texture change occurs that comprises a change of one or more of the following: softness, crunchiness, tenderness, chewiness, crispiness, and temperature-induced sensation.

In some cases, the edible, shape-transforming film interacts with other food materials that are in solid or liquid form. For example, the film may, while it transforms in shape, interact with fish caviars, meat balls, chopped vegetable or herbs, chicken soup, fluid juice, milk, or coffee.

In illustrative implementations, the shape-transforming structure (e.g., gelatin film with fiber strips) is safe and edible.

The Summary and Abstract sections and the title of this document: (a) do not limit this invention; (b) are intended only to give a general introduction to some illustrative implementations of this invention; (c) do not describe all of the details of this invention; and (d) merely describe non-limiting examples of this invention. This invention may be implemented in many other ways. Likewise, the description of this invention in the Field of Technology section is not limiting; instead it identifies, in a general, non-exclusive manner, a field of technology to which some implementations of this invention generally relate.

### BRIEF DESCRIPTION OF THE DRAWINGS

FIGS. 1A, 1B and 1C show a gelatin film, at various stages of drying.

FIG. 2 shows an edible film comprising, from top to bottom, fiber strips, a layer of dense gelatin and a layer of porous gelatin.

FIGS. 3A-3D show examples of bending directions.

FIG. 3A shows a film that curves in a direction perpendicular to longitudinal axes of fiber strips. FIG. 3B shows a cross-sectional view of the bent film in FIG. 3A.

FIG. 3C shows a film that curves along longitudinal axes of fiber strips. FIG. 3D shows a cross-sectional view of the bent film in FIG. 3C.

FIGS. 4A, 4B, 4C, 4D and 4E show a time sequence, in which; (a) a film changes shape from flat to curved; and (b) the curvature is along longitudinal axes of fiber strips.

FIGS. 5A, 5B, 5C, 5D, and 5E show a time sequence, in which: (a) a film changes shape from flat to curved; and (b) the curvature is perpendicular to longitudinal axes of fiber strips.

FIGS. 6A, 6B, 6C, 7A, 7B, 7C, 8A, 8B, 8C, 9A, 9B, 9C, 10A, 10B, 10C, 11A, 11B, 11C, 12A, 12B, 12C, 13A, 13B, 13C, 14A, 14B, 14C, 15A, 15B, 15C, 16A, 16B, 16C, 17A, 17B, 17C, 18A, 18B, 18C, 19A, 19B, 19C, 20A, 20B, and 20C show examples of shape transformations that different edible structures undergo when exposed to moisture. Each of these edible structures is a composite structure that comprises a gelatin film and fiber strips. Furthermore, each of these edible structures has—when viewed from the top while dry—a particular shape of gelatin film and a particular pattern of fiber strips.

FIG. 21 shows gelatin film wrapped around caviar.

FIG. 22 shows a CNC printer.

FIG. 23 is a flow chart for a method of fabricating a two-layer gelatin structure, the top layer being denser than the bottom layer.

FIG. 24 is a flow chart for a method of fabricating an edible structure and then causing it to change shape by exposing it to water.

FIGS. 25 and 26 are flow charts for methods of fabricating an edible structure and then causing it to undergo a temperature-dependent shape transformation,

FIG. 27 is a flow chart for a method in which an interactive UI (user interface) facilitates selection of parameters of cellulose strips that affect bending behavior of an edible structure.

The above Figures show some illustrative implementations of this invention, or provide information that relates to those implementations. The examples shown in the above Figures do not limit this invention. This invention may be implemented in many other ways.

### DETAILED DESCRIPTION

### Shape Transformation When Exposed to Water

In some implementations of this invention, the shape of an edible structure changes when the edible structure is exposed to water.

In some implementations, the edible, shape-transforming structure is a composite film that comprises gelatin and fibers. When exposed to water, the gelatin tends to expand. The edible fibers may constrain the expansion, causing the film to bend in a controlled manner into pre-determined shapes. The orientation, density and thickness of the fibers in the composite film may be selected in such a way as to control the transformation of shape of the film when the film is exposed to water (including controlling the intermediate and final shapes that occur in response to changes in water).

In some implementations, the edible fibers comprise ethyl cellulose. In some implementations, flavoringₛ coloring agents or other edible additives are included in the film (e.g., in the gelatin or fibers of the film).

Gelatin has at least six advantages, when used in an edible shape-transforming film. First, gelatin dissolves well in solution before the gelation process, making it easier to achieve uniformity of the food gel before drying. Second, different types of gelatin are commercially available. These commercially available types of gelatin include gelatins with different molecular weights (or Bloom numbers) and thus different chemical and physical properties. Third, there are different sources of gelatin (e.g. from porcine skin, cattle bones), to suit diners' specific needs (e.g. gluten free). Fourth, a gelatin-air surface tends to be very flat. Fifth, gelatin tends to be easily detachable from a container in which the gelatin gels (e.g. petri dish). Sixth, gelatin is edible.

Ethyl cellulose has at least five advantages, when used as a fiber in an edible film, where the film changes shape when exposed to water. First, ethyl cellulose is well-suited for being deposited by a 3D printer or other CNC printer, because (a) ethyl cellulose is easily dissolved in alcohol (e.g., food-grade ethanol), (b) the resulting solution may be easily extruded by the printer; and (c) alcohol may evaporate from the solution after it is extruded, resulting in ethyl cellulose fibers. Second, the fact that ethyl cellulose may be easily deposited by a CNC printer, in turn, means that orientation, thickness and density of the ethyl cellulose fibers may be precisely controlled by the CNC printer that is depositing the fibers. As noted above, by controlling these parameters of the fibers (orientation, density and thickness), the shape transformation of the film (in response to exposure to water) may be controlled. Third, ethyl cellulose fibers have a tensile strength. Thus, when these fibers are included in a composite film, they may constrain expansion and movement of gelatin in the film, while the gelatin swells in response to being exposed to water. Fourth, ethyl cellulose may, when interposed between water source and gelatin, function as a water barrier that affects swelling behavior of the gelatin beneath it. Fifth, ethyl cellulose is edible.

In some implementations of this invention, density of the gelatin in the gelatin portion of the film may vary from top to bottom, with a top layer of the gelatin being denser than a bottom layer of the gelatin. Put differently, a bottom layer of the gelation may be more porous than a top layer of the gelatin.

This non-homogeneous distribution of density of the gelatin may be achieved by allowing water to evaporate from only the top—and not from the sides or bottom—of an aqueous solution of gelatin. For example, the water evaporation may occur while the aqueous gelatin solution is in a Petri dish.

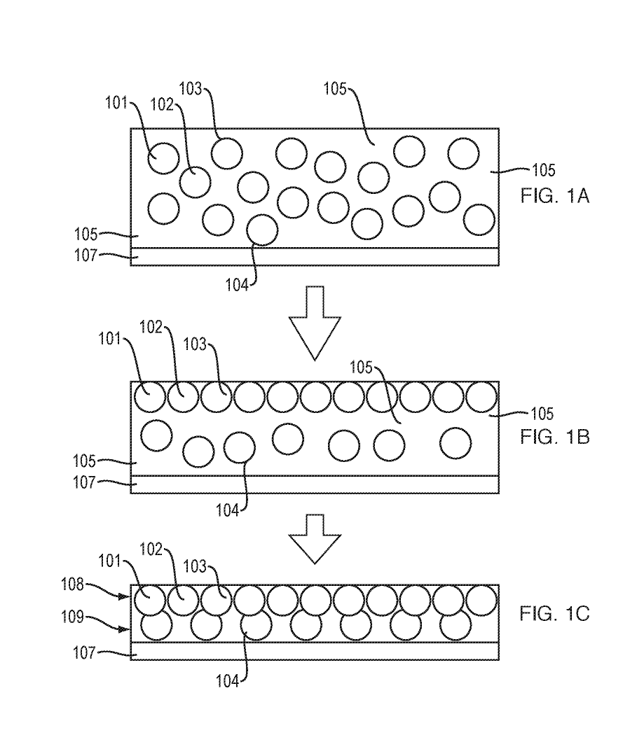

FIGS. 1A, 1B and 1C show a gelatin film, at various stages of drying, in an illustrative implementation of this invention. In FIG. 1A, gelatin particles (e.g., 101, 102, 103, 104) comprising peptides and proteins are surrounded by water 105 that is contained in a petri dish 107. In FIG. 1B, the gelatin has partially dried, by evaporation from the top. As a result of this evaporation, many of the gelatin particles (e.g. 101, 102, 103) are aggregated close to each other in an upper region of the gelatin, while some of the gelatin particles (e.g., 104) that in a lower region of the gelatin are surrounded by more water and thus more dispersed from each other. In FIG. 1C, the gelatin has further dried by evaporation from the top, resulting in a top layer 108 of gelatin and a bottom layer 109 of gelatin. In FIG. 1C: (a) the volumetric mass density of the top gelatin layer 108 is greater than the volumetric mass density of the bottom gelatin layer 109; and (b) the bottom gelatin layer 109 is more porous than the top gelatin layer 108.

As shown in FIG. 1B, the solid-air boundary contains a higher concentration of gelatin, due to surface aggregation of the gelatin solids toward the interface. After forming a dried top layer, water evaporation in lower portion of the film becomes restricted. This results in the formation of gelatin film with a denser top layer and a looser, more porous bottom layer, as shown in FIG. 1C.

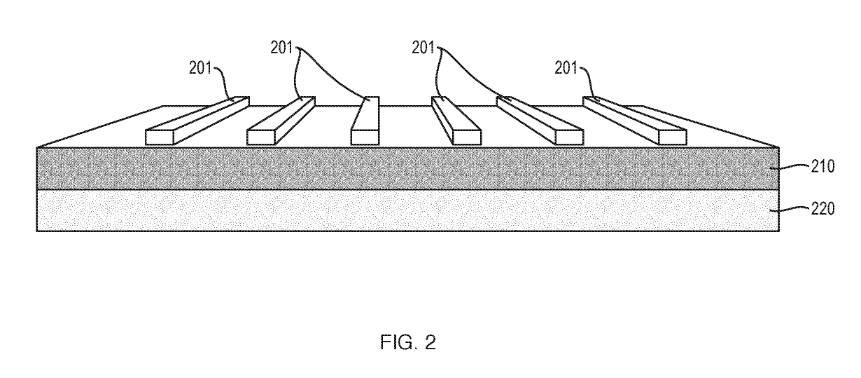

FIG. 2 shows an edible film, in an illustrative implementation of this invention. The edible film comprises, from top to bottom, fiber strips 201, a layer of dense gelatin 210 and a layer of porous gelatin 220.

The following two paragraphs describe a prototype of this invention.

In this prototype, a gelatin film with a denser top layer and more porous bottom layer is prepared as follows: Gelatin is dissolved in water in a large (15 cm) Petri dish at a concentration (3-12%) at room temperature for complete hydration (about 15 min). The solution is then transferred to a hotplate at ˜60° C. to ensure total melting of the solids in aqueous solution. Alternatively, the solution is heated in a microwave (high heat for 1-2 min) to ensure total melting of the solids in the aqueous solution. In some cases, the liquid in which the gelatin is dissolved comprises water. This may result in a transparent and flavorless gelatin film. In some cases, flavors are added. For example, in some cases, fruit punch, vegetable juice, or seafood extract are added to the aqueous solution or are used instead of water. After the solids are completely melted in the solution, varying amounts (12-60 mL) of solution are transferred into a petri dish by pipet, to form different thicknesses of gel. The gel is cured at room temperature for about 5 min, and transferred to a windy area with fans to allow one-directional water evaporation (12-18 hours).

In this prototype, ethyl cellulose strips are prepared as follows. Ethyl cellulose solid materials are dissolved in 95% food-grade ethanol (5-30 w/v %), in a slightly heated water bath (˜50° C.). A CNC device then deposits the ethyl cellulose solution in a selected pattern on the gelatin film. After the ethyl cellulose solution is deposited on the gelatin film, alcohol evaporates from the ethyl cellulose solution, resulting in cured strips of ethyl cellulose fibers on top of the gelatin film.

The prototype described in the preceding two paragraphs is a non-limiting example; this invention may be implemented in many other ways.

As noted above, in some implementations, ethyl cellulose fibers are printed on top of dried gelatin to produce a composite film. These printed cellulose fibers may be rigid or strong (e.g., tensile strength) when cured (i.e., after evaporation of the alcohol). Thus, when cured, these fibers may function as shape constraints that control the bending direction of the film while the gelatin swells during hydration. Furthermore, because ethyl cellulose absorbs only a minimal amount of water, ethyl cellulose fibers may also function as a water barrier that decreases the rate at which water is absorbed through the top of the film (because only the portions of the top of the film that are not covered by the ethyl cellulose fibers tend to rapidly absorb water).

In some implementations, a composite film (comprising a gelatin film with ethyl cellulose fibers printed on top of the gelatin) is exposed to water (e.g., by immersing it in water). This may cause the film to absorb water and to swell. This swelling during hydration may cause sequential shape transformations of the composite film. For example, as the gelatin swells, the film may: (a) first bend upward in such a way that ends of the composite film move upward, causing these ends to be higher than the middle of the film, and (b) then bend downward in such a way that ends of the composite film move downward, causing these ends to be lower than the middle of the film. For example, if the gelatin film is a flat shape that approximates a rectangle, the ends that move upward and downward may be located at any two opposite ends of the rectangle.

In some implementations, printed ethyl cellulose strips may regulate bending direction of a composite film (comprising gelatin and the cellulose strips) and may thereby cause dynamic shape changes during hydration of the composite film. The printed ethyl cellulose strips may control bending of the composite film. This control may be achieved (a) due to the rigidity of the strips and their locations on the film; and (b) due to strips acting as water barriers and thus decreasing water absorption area on the top of the composite film.

In some implementations, a composite film (comprising gelatin with cellulose strips) is immersed into water.

Initially, the composite film may bend upward (that is, bend so that ends of the composite film are higher than the middle of the film). This upward bending may be because the bottom gelatin layer exhibits a higher water absorption rate than the top gelatin layer, due to a relatively larger water contact area.

After a specified duration, the bending direction may reverse and the composite film may bend downward (that is, bend so that the ends of the composite film are lower than the middle of the film). The downward bending may occur because the top gelatin layer has a greater capacity to absorb water and swell than the bottom layer (because the top gelatin layer is denser and thus has more gelatin particles in it than the bottom gelatin layer). The downward bending may occur after the initial upward bending because the top gelatin layer may absorb water at a slower rate than the bottom gelatin layer, due to the presence of printed cellulose strips that cover a portion of the top surface of the gelatin and act as a water barrier.

The specific duration (i.e. amount of time that elapses from immersion of the composite film in water until downward bending starts) may depend on the rate at which water is absorbed through the top of the composite film. This rate, in turn, may be controlled by controlling the thickness of the cellulose strips and the density of the cellulose strips (e.g., the number of cellulose strips per unit of area of the top surface of the composite film).

In some implementations, the gelatin film with cellulose strips is immersed in water and becomes increasingly hydrated. As the water content of the gelatin increases, the gelatin film may change from a glassy state to a rubber-like state.

In some cases, as the gelatin strip becomes increasingly hydrated, the composite film bends along longitudinal axes of the cellulose strips.

However, in some other cases, the composite film bends in a direction perpendicular to the longitudinal axes of the cellulose strips.

Alternatively, in some cases, the composite film bends in such a way that the bending includes a component that is along the longitudinal axes of the cellulose strips and also includes a component that is perpendicular to the longitudinal axes of the cellulose strips.

In some implementations, whether the gelatin film bends along the longitudinal axes of the cellulose strips or bends perpendicular to these longitudinal axes (or both) depends in part on the stiffness of the cellulose strips. In some cases, when the cellulose strips are parallel to each other and are thick and stiff, the gelatin film bends in a direction perpendicular to the longitudinal axes of the cellulose strips (because the strips are so stiff that it is difficult to bend them). In some other cases, when the cellulose strips are parallel to each other and are more flexible, the gelatin film bends along the longitudinal axes of the cellulose strips.

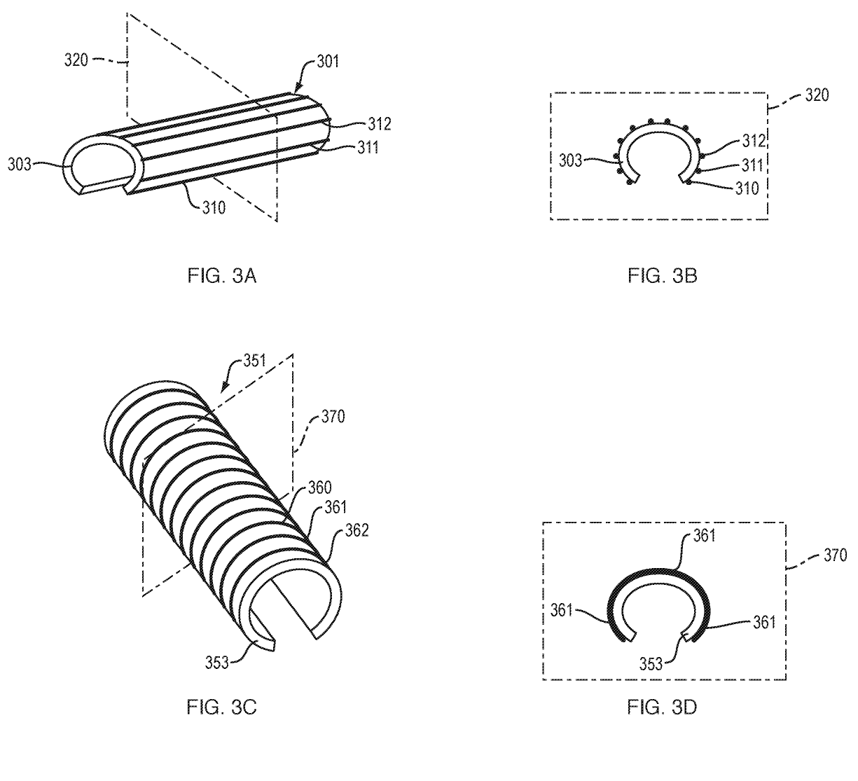

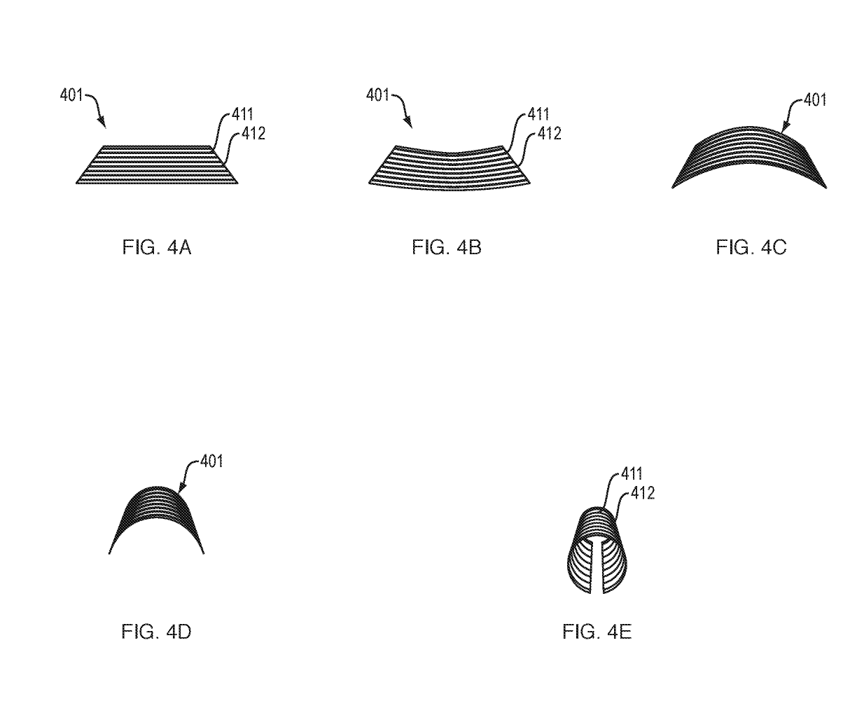

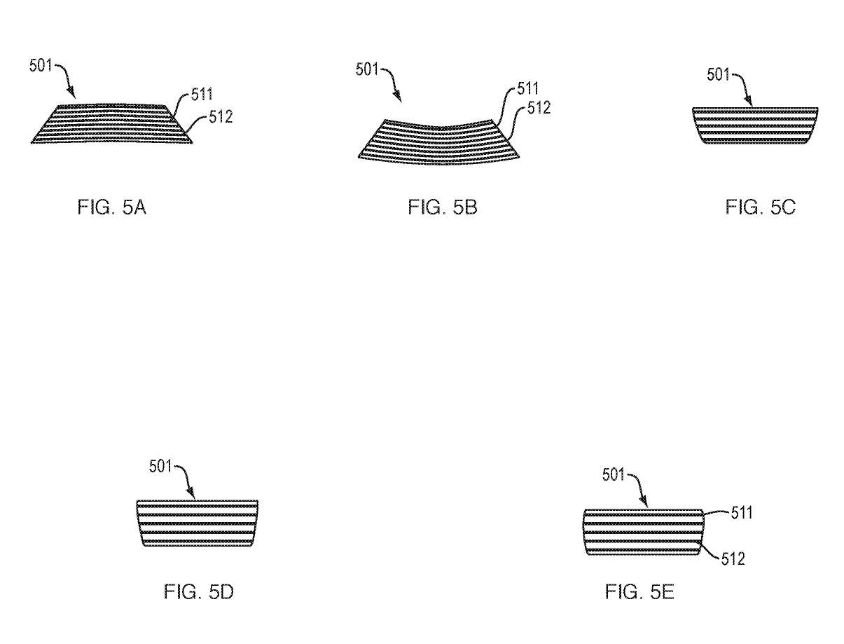

FIGS. 3A-3D show examples of bending directions, in an illustrative implementation of this invention.

FIG. 3A shows a composite film 301 that is bent in a direction perpendicular to the longitudinal axes of cellulose fiber strips. This type of bending may occur when the cellulose fibers are relatively stiff.

In FIG. 3A, composite film 301 comprises a gelatin film 303 with a set of cellulose fiber strips (e.g., 310, 311, 312) that are printed on the gelatin film 303.

FIG. 3B shows a cross-sectional view of the bent film in FIG. 3A.

In FIGS. 3A and 3B, the longitudinal axes of the fiber strips (e.g., 310, 311, 312) are not curved, even though the composite film 301 (and the gelatin film 303 that is part of the composite film) are curved.

In FIGS. 3A and 3B, the fiber strips are parallel to each other. In FIGS. 3A and 3B, a cross-sectional plane 320 is perpendicular to a surface normal of the curved surface of gelatin film 303 and is also perpendicular to the longitudinal axes of the fiber strips (e.g., 310, 311, 312).

FIG. 3C shows a composite film 351 that is bent along the longitudinal axes of cellulose fiber strips. This type of bending may occur when the cellulose fibers are relatively flexible.

In FIG. 3C, composite film 351 comprises a gelatin film 353 with a set of cellulose fiber strips (e.g., 360, 361, 362) that are printed on the gelatin film 353.

FIG. 3D shows a cross-sectional view of the bent film in FIG. 3D.

In FIGS. 3C and 3D, the longitudinal axes of the fiber strips (e.g., 360, 361, 362) are curved, due to the bending of the composite film 351.

In FIGS. 3C and 3D, the fiber strips are parallel to each other. In FIGS. 3C and 3D, a cross-sectional plane 370 is perpendicular to a surface normal at a point on the curved surface of the gelatin film 353 and is parallel to the longitudinal axes of the fiber strips (e.g., 360, 361, 362).

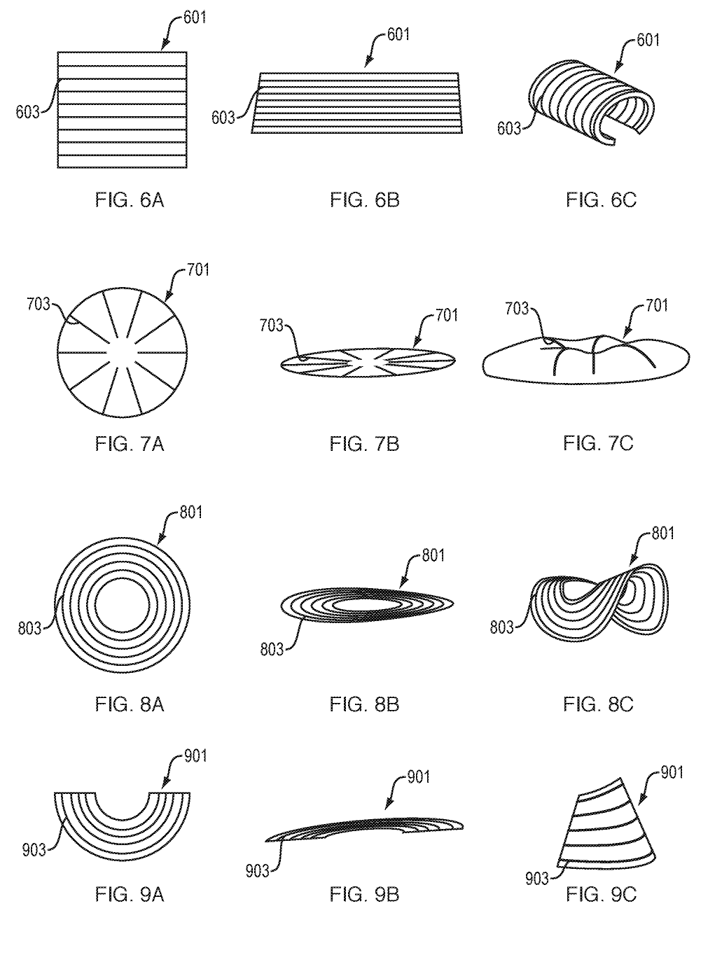

FIGS. 4A, 4B, 4C, 4D and 4E show a time sequence, in an illustrative implementation of this invention. In this time sequence: (a) while film 401 hydrates, it changes shape from flat to curved; and (b) the curvature is along the longitudinal axes (e.g., 411, 412) of the fiber strips. In some cases, this type of curvature (along the longitudinal axes) occurs where the fiber strips are relatively flexible. When film 401 is exposed to water, the ends of film 401 initially bend slightly upward (as shown in FIG. 4B), then later the ends of film 401 bend downward (as shown in FIGS. 4C, 4D, 4E).

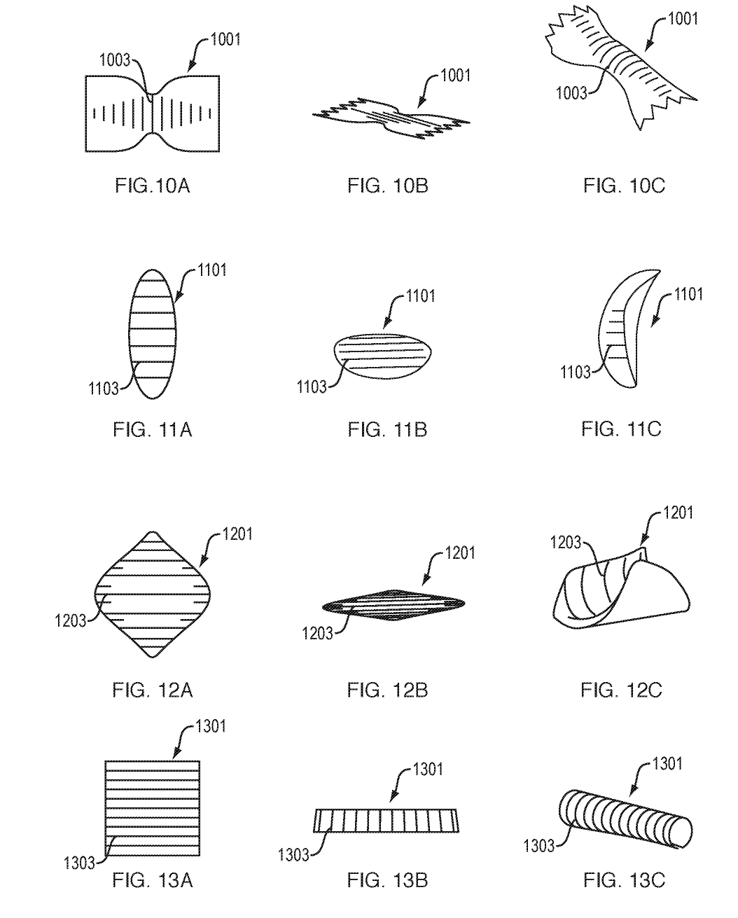

FIGS. 5A, 5B, 5C, 5D and 5E show a time sequence, in an illustrative implementation of this invention. In this time sequence, while film 501 hydrates, it changes shape from flat to curved. In FIGS. 5C, 5D, 5E, the curvature is in a direction perpendicular to the longitudinal axes (e.g., 511, 512) of the fiber strips. In some cases, this type of curvature (perpendicular to the longitudinal axes) occurs where the fiber strips are relatively stiff and thick. When film 501 is exposed to water, the film 501 initially bends slightly upward (as shown in FIG. 5B), then later bends downward (as shown in FIGS. 5C, 5D, 5E).

In some cases, fibers are printed on a gelatin film in parallel straight lines, in such a way that the film bends about a single straight axis as the film becomes increasingly hydrated (as shown in FIGS. 4A-5D).

Alternatively, in some cases, fibers are printed on a gelatin film in non-parallel straight lines, in such a way that the film bends about more than one straight axis as the film becomes increasingly hydrated. In yet other cases, fibers are printed on a gelatin film in parallel or non-parallel curved lines, in such a way that the film bends about more one or more curved axes as the film becomes increasingly hydrated. In some cases, fibers are printed on a gelatin film in such a way that the film bends into a saddle shape, cone shape, or flower shape as the film becomes increasingly hydrated.

In some cases: (a) a wide variety of shapes may be produced as the film swells (due to absorbing water); and (b) which specific shape is produced may be precisely controlled by controlling parameters of the film such as orientation, thickness and density of fibers printed on the film or regarding the perimeter shape of the gelatin film when the film is dry and flat. In some cases, a set of basic shapes may be used as a basic grammar for producing more complex shape transformations.

For example, in some implementations, edible flat films transform into different 3D curved shapes, depending on how parameters of the films are adjusted, including gelatin sheet geometry (e.g. disk, oval shape, S-shape) and edible fiber properties (e.g. cellulose density and thickness, line gap, total coverage). By adjusting these parameters, the rigidity of shape constraints and water diffusion rate may be modulated.

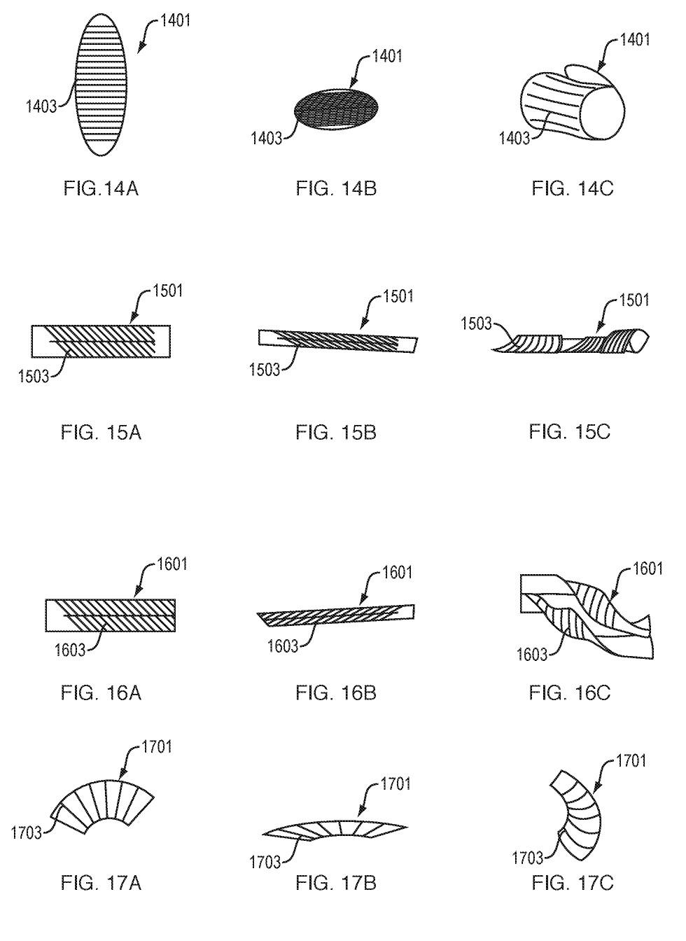

FIGS. 6A-20C show examples of shape transformations that different edible structures undergo when exposed to water, in illustrative implementations of this invention. In FIGS. 6A-20C, each of these edible structures is a composite structure that comprises gelatin and fiber strips. Furthermore, each of these edible structures has—when viewed from an orthogonal top view while the structure is dry and flat—a particular pattern of fiber strips and a particular two-dimensional shape of gelatin

FIGS. 6A, 7A, 8A, 9A, 10A, 11A, 12A, 13A, 14A, 15A, 16A, 17A, 18A and 19A, each, respectively, show an orthogonal top view of a flat dry gelatin film (e.g., 601, 701, 801, 901, 1001, 1101, 1201, 1301, 1401, 1501, 1601, 1701, 1801, 1901) and show a set of edible fibers (e.g. 603, 703, 803, 903, 1003, 1103, 1203, 1303, 1403, 1503, 1603, 1703, 1803, 1903) printed on the film. FIG. 20A shows an orthogonal top view of a flat dry gelatin film 2001.

FIGS. 6B and 6C show an intermediate shape and a final shape, respectively, of film 601 that occur in a shape transformation of film 601 as film 601 hydrates.

FIGS. 7B and 7C show an intermediate shape and a final shape, respectively, of film 701 that occur in a shape transformation of film 701 as film 701 hydrates.

FIGS. 8B and 8C show an intermediate shape and a final shape, respectively, of film 801 that occur in a shape transformation of film 801 as film 801 hydrates.

FIGS. 9B and 9C show an intermediate shape and a final shape, respectively, of film 901 that occur in a shape transformation of film 901 as film 901 hydrates.

FIGS. 10B and 10C show an intermediate shape and a final shape, respectively, of film 1001 that occur in a shape transformation of film 1001 as film 1001 hydrates.

FIGS. 11B and 11C show an intermediate shape and a final shape, respectively, of film 1101 that occur in a shape transformation of film 1101 as film 1101 hydrates.

FIGS. 12B and 12C show an intermediate shape and a final shape, respectively, of film 1201 that occur in a shape transformation of film 1201 as film 1201 hydrates.

FIGS. 13B and 13C show an intermediate shape and a final shape, respectively, of film 1301 that occur in a shape transformation of film 1301 as film 1301 hydrates.

FIGS. 14B and 14C show an intermediate shape and a final shape, respectively, of film 1401 that occur in a shape transformation of film 1401 as film 1401 hydrates.

FIGS. 15B and 15C show an intermediate shape and a final shape, respectively, of film 1501 that occur in a shape transformation of film 1501 as film 1501 hydrates.

FIGS. 16B and 16C show an intermediate shape and a final shape, respectively, of film 1601 that occur in a shape transformation of film 1601 as film 1601 hydrates.

FIGS. 17B and 17C show an intermediate shape and a final shape, respectively, of film 1701 that occur in a shape transformation of film 1701 as film 1701 hydrates.

FIGS. 18B and 18C show an intermediate shape and a final shape, respectively, of film 1801 that occur in a shape transformation of film 1801 as film 1801 hydrates.

FIGS. 19B and 19C show an intermediate shape and a final shape, respectively, of film 1901 that occur in a shape transformation of film 1901 as film 1901 hydrates.

FIGS. 20B and 20C show an intermediate shape and a final shape, respectively, of film 2001 that occur in a shape transformation of film 2001 as film 2001 hydrates.

In some implementations, the shape-transforming film interacts with other edible materials.

For example, in a use case of this invention, a transparent edible film wraps around fish caviar when the film is immersed in water that contains the caviar. This “self-wrapping caviar cannoli” may be fabricated as follows: Prepare edible gelatin gel at 6% w/v in drinkable water in a flat-bottom dish. Screen print cellulose solution (15%) on the gelatin film: line thickness (1 mm), line gap (3 mm). For a comfortable texture in-mouth, prepare a composite film of gelatin-agar without cellulose strips. Cut into square shape (2×2 cm) and emerge it into water with caviar at 35° C. Stir solution to have caviar present along both sides of the film. The shape transformation may occur within 2 minutes.

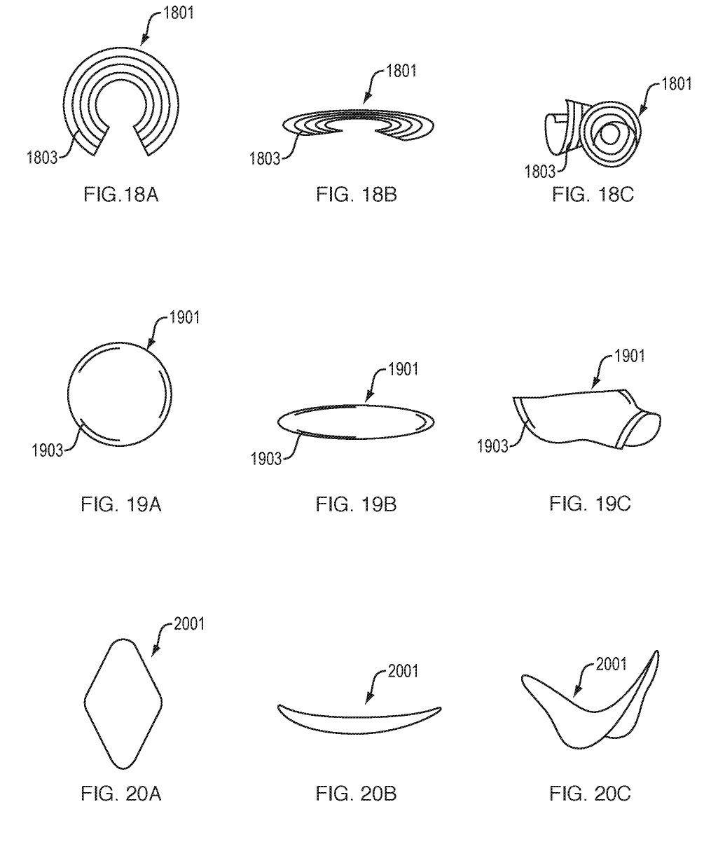

FIG. 21 shows a transparent gelatin film 2101 that has wrapped itself around fish caviar 2103, in an illustrative implementation of this invention. This wrapping around the caviar may occur as the gelatin swells after being partially or entirely immersed in liquid. In some implementations, the “self-wrapping” (of the gelatin film around the caviar) may be achieved by controlling the geometry and thickness of the gelatin film, the folding curvature, the water temperature (and thus hydration speed), and the density of caviar suspended in water.

In another use case of this invention, gelatin and cellulose are combined to create a fruity pasta, according to the following recipe: Prepare edible gelatin gel at 6% w/v with flavored liquid (squid ink, potato extract, seaweed) in a flat-bottom dish. Dry the film in kitchen with a fan for 12 hours. Digitally print cellulose solution (30%) on gelatin film with the following parameters: line gap (based on geometry), solution deposition speed (20 μL/min), gap between dispensing tip and gelatin film (0.3 mm), and tip diameter (0.010″). Cut the film into different shapes and immerse into water at 30° C. The shape transformation may occur within two minutes.

The caviar cannoli and fruity pasta use cases described above are non-limiting examples; this invention may be implemented in other ways.

In some implementations of this invention, a CNC printer deposits one or more materials that dry or cure into edible fiber strips. For example, in some implementations: (a) the printer extrudes a mixture of ethyl cellulose and food grade ethanol in such a way that strips of the mixture are deposited on a gelatin film; and (b) then the ethanol evaporates, causing the mixture to cure into strips of ethyl cellulose fiber.

In some implementations, a CNC printer may deposit one or more fiber materials according to digital computer instructions. For example, the CNC printer may comprise any type of 3D printer.

In some implementations, digital instructions may cause the CNC printer to fabricate a particular pattern of edible fibers (e.g., ethyl cellulose fibers) on a gelatin film. The digital instructions (e.g., G-codes) for controlling the CNC printer may be outputted by a computer. The computer may accept user inputs regarding a desired shape transformation, then calculate fiber parameters that will achieve the desired shape transformation, and then output digital instructions (e.g., G-codes) that instruct the CNC printer to deposit fiber in a manner that satisfies these parameters. Advantageously, the CNC printer may deposit the fiber material(s) with great precision.

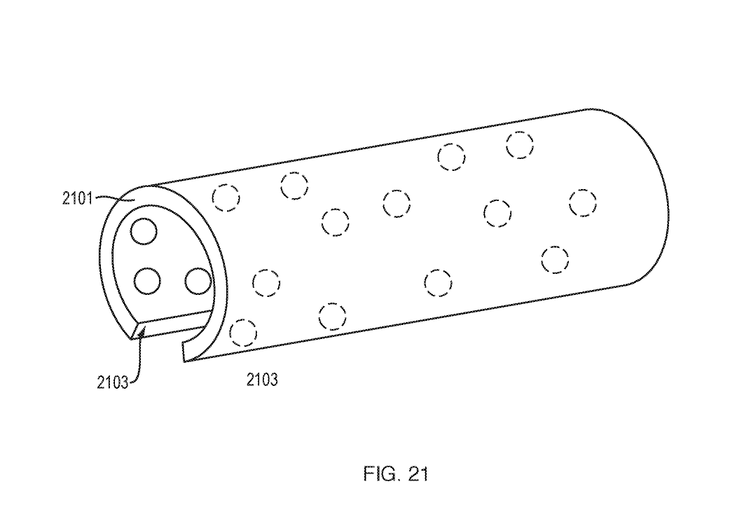

FIG. 22 shows a CNC printer, in an illustrative implementation of this invention. In the example shown in FIG. 22, the CNC printer 2200 includes an x-axis actuator 2203, a y-axis actuator 2212 and a z-axis actuator 2205. These three actuators each, respectively, move along guide poles. Each of these three actuators may include one or more electric motors (e.g., stepper motors). The x-axis and z axis actuators actuate horizontal x and vertical z movements of a mounting plate 2209 to which a printhead is attached. The printhead includes a container 2225 that stores printing solution, a nozzle 2223 and a nozzle tip 2227. Optionally, in some cases, the printhead further comprises a first heating or cooling device 2231 that heats or cools material in the container 2225 and a second heating or cooling device 2233 that heats or cools material in the nozzle 2223. For example, the heating or cooling devices 2231, 2233 may each, respectively, comprise a Peltier thermoelectric heat pump that may heat material (in the nozzle or container) at some times and cool material (in the nozzle or container) at other times. One or more computers (e.g., microcontroller 2211) may control movement of the actuators and deposition or extrusion of a printing solution (e.g., a mixture of ethyl cellulose and ethanol). An additional computer 2250 may, among other things: (a) perform a computer-assisted design program for designing shape-transforming food; and (b) control a UI (user interface) 2252.

In the example shown in FIG. 22, the gelatin film (onto which the cellulose strips are being printed) may rest on a print bed 2207. A y-axis actuator 2212 may actuate movement of the print bed 2207. Thus, taken together, the x-, y- and z-axis actuators actuate x-, y- and z-axis movements of the nozzle relative to the print bed.

The example shown in FIG. 22 is non-limiting; other types of CNC printer may be employed. For example, in some cases: (a) the z-axis actuator may be omitted; and (b) the CNC printer may print only a two-dimensional pattern. For example, in some cases: (a) the x-axis actuator and y-axis actuator both actuate movement of the printhead; and (b) the z-axis actuator is omitted.

In a prototype of this invention, a CNC printer dispenses the cellulose onto a gelatin film. Several parameters are tunable during printing, including cellulose concentration (5-30%) that changes viscosity, line gap (1-5 mm), solution deposition speed (5-300 μL/min), gap between dispensing tip and gelatin film (0.1-0.5 mm), and tip diameter (0.008″ to 0.024″), to achieve desired cellulose line thickness, height, and area coverage. A problem that arose for this prototype is that cellulose prepared in ethanol tends to easily solidify (and thus clog the CNC printer), due to evaporation of ethanol from a windy fume hood of the solution reservoir of the CNC printer. This problem may be avoided (and the clogging prevented), by attaching a seal cap with a long tubing outlet to the top of the solution reservoir of the CNC printer. Before each printing, pre-extrusion at high flow rate (50 μL/min) may be performed to ensure printing efficacy. Regular cleaning using 95% ethanol may also be used to clean the CNC printer between runs on different days. The prototype described in this paragraph is a non-limiting example; this invention may be implemented in many other ways.

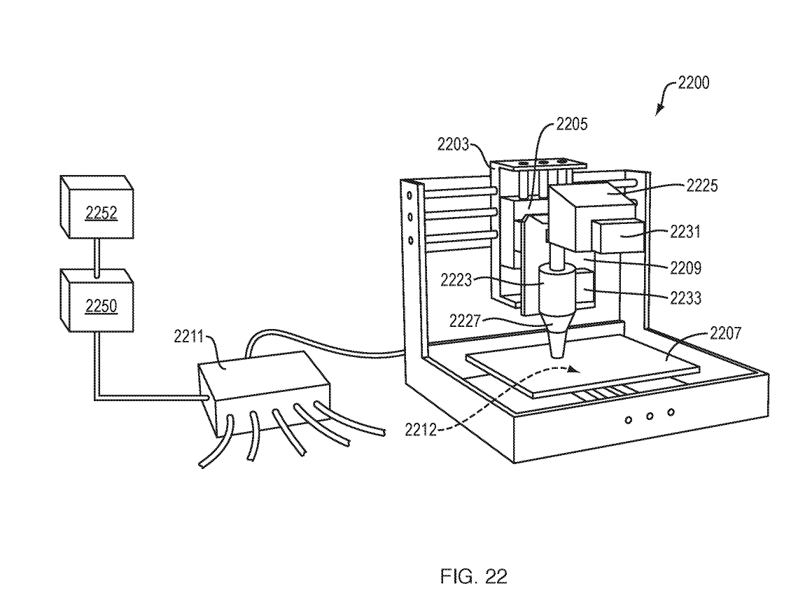

FIG. 23 is a flow chart for a method of fabricating a two-layer gelatin structure, the top layer being denser than the bottom layer, in an illustrative implementation of this invention. The method shown in FIG. 23 includes the following steps: Create a gelatin film that comprises a bottom layer and a top layer (the top layer being denser than the bottom layer), by pouring a gelatin solution into a container and evaporating only from the top of the gelatin (Step 2301). Create a composite structure, by printing edible fiber strips on top of the gelatin film. The strips may comprise a mixture of ethyl cellulose and food-grade ethanol (Step 2302). Hydrate the composite structure, causing the structure to bend, in such a way that the amount and direction of bending changes over time until achieving a final shape (Step 2303).

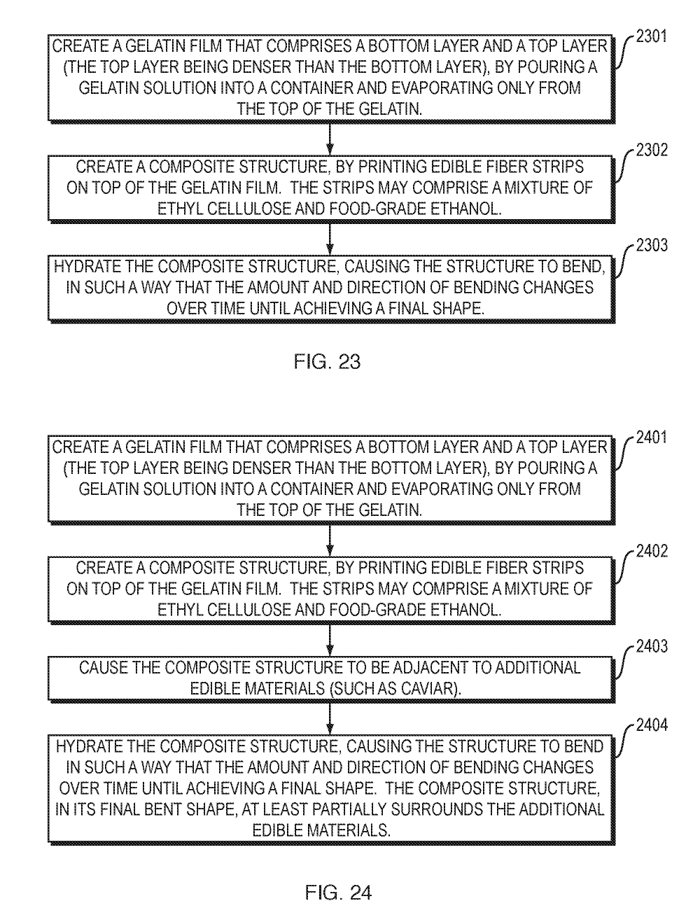

FIG. 24 is a flow chart for a method of fabricating an edible structure and then causing it to bend by exposing it to water, in an illustrative implementation of this invention. The method shown in FIG. 24 includes the following steps: Create a gelatin film that comprises a bottom layer and a top layer (the top layer being denser than the bottom layer), by pouring a gelatin solution into a container and evaporating only from the top of the gelatin solution (Step 2401). Create a composite structure, by printing edible fiber strips on top of the gelatin film. The strips may comprise a mixture of ethyl cellulose and food-grade ethanol (Step 2402). Cause the composite structure to be adjacent to additional edible materials (such as caviar) Step 2403). Hydrate the composite structure, causing the structure to bend in such a way that the amount and direction of bending changes over time until achieving a final shape. The composite structure, in its final bent shape, at least partially surrounds the additional edible materials (Step 2404).

### Temperature-Dependent Shape Transformation

In some implementations of this invention, temperature of gelatin is controlled, which in turn affects swelling and melting of the gelatin.

The extent to which gelatin swells as it becomes hydrated may depend on the temperature of the gelatin. For example, in some cases, in a temperature range of 10° C. to 40° C., the higher the temperature of gelatin, the greater the swelling of the gelatin when it is exposed to water. Thus, a gelatin film may absorb water at a faster rate in hot water than in cold water.

Also, gelatin has a low melting point. High molecular weight gelatin may begin to melt at ˜40° C., and low molecular weight gelatin may begin to melt at ˜20° C.

In some implementations, the temperature of gelatin is controlled, while the gelatin hydrates. The temperature of the gelatin may, in turn, determine whether the gelatin is in solid state or liquid state.

In some implementations of this invention, a composite structure includes temperature-sensitive hinges that comprise low molecular weight gelatin. The temperature of the gelatin may be controlled to achieve programmable breakage of these temperature-sensitive hinges due to melting.

In some implementations, different layers of gelatin with different Bloom numbers may be included in a gelatin film, and the different layers may respond to water differently at relatively high temperatures (>35° C.). For example, in some implementations, a gelatin film may comprise a top gelatin layer and a bottom gelatin layer, the top layer having a higher Bloom number than the bottom layer. When cooking at relative low temperature (˜25° C.), the linkage formed by the higher Bloom number gelatin may maintain solid state and retain a given shape (e.g., a long thread shape of a noodle). In contrast, at high cooking temperature (˜40° C.), linkage between segments of the film may dissolve and the film may break apart (e.g., into shortened and twisted segments). The wrapping direction of these segments may be controlled by adding another layer of cellulose on top of the gelatin film.

In some use cases of this invention, temperature-responsive noodles are prepared according to the following recipe: Prepare a gel with high Bloom gelatin (6% w/v) in seaweed extract. Dry it and cut it into small rectangular shapes (1×2 9cm). Afterward, prepare another gel with low Bloom gelatin (6% w/v) in a seaweed extract as well. Assemble the rectangular high Bloom pieces on the new prepared wet low Bloom gelatin gel. Dry it for 18 hours. Print cellulose in lines with the following parameters with two different orientations: line thickness (1 mm), line gap (3 mm). Cut into long strips. Prepare a chicken soup with a temperature maintained at 37.5 ° C. Dip the strips into the soup and the shape transformation may occur within 5 minutes. The use case in this paragraph is a non-limiting example of this invention.

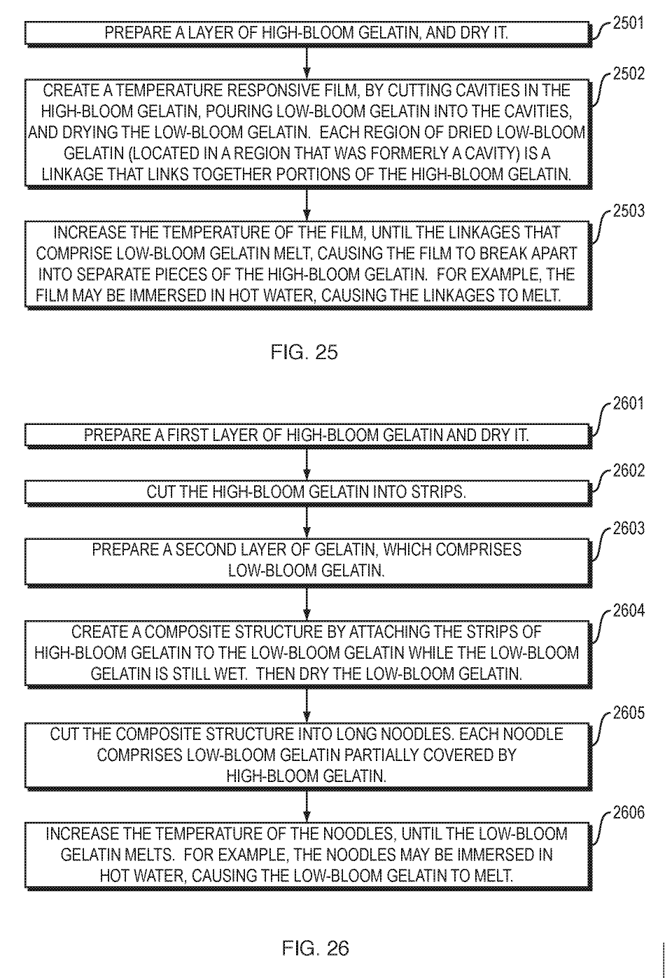

FIGS. 25 and 26 are flow charts for methods of fabricating an edible structure and then causing it to undergo a temperature-dependent shape transformation, in illustrative implementations of this invention.

The method shown in FIG. 25 includes the following steps: Prepare a layer of high-bloom gelatin, and dry it (Step 2501). Create a temperature responsive film, by cutting cavities in the high-bloom gelatin, pouring low-bloom gelatin into the cavities, and drying the low-bloom gelatin. Each region of dried low-bloom gelatin (located in a region that was formerly a cavity) is a linkage that links together portions of the high-bloom gelatin (Step 2502). Increase the temperature of the film, until the linkages that comprise low-bloom gelatin melt, causing the film to break apart into separate pieces of the high-bloom gelatin. For example, the film may be immersed in hot water, causing the linkages to melt (Step 2503).

The method shown in FIG. 26 includes the following steps: Prepare a first layer of high-bloom gelatin and dry it (Step 2601). Cut the high-bloom gelatin into strips (Step 2602). Prepare a second layer of gelatin, which comprises low-bloom gelatin (Step 2603). Create a composite structure by attaching the strips of high-bloom gelatin to the low-bloom gelatin while the low-bloom gelatin is still wet. Then dry the low-bloom gelatin (Step 2604). Cut the composite structure into long noodles. Each noodle comprises low-bloom gelatin partially covered by high-bloom gelatin (Step 2605). Increase the temperature of the noodles, until the low-bloom gelatin melts. For example, the noodles may be immersed in hot water, causing the low-bloom gelatin to melt (Step 2606).

The following three paragraphs describe an alternate prototype of this invention that employs temperature-controlled printing of an edible film.

In this prototype, a two-syringe desktop CNC printer is employed for temperature-controlled printing of multiple materials at the same time. In this prototype, the two-syringe CNC printer includes: (a) an open source 3Drag printer chassis; (b) Choco syringe extruders; and (b) a refrigeration system to rapidly solidify warmed material during printing. Use of the two syringes may facilitate printing two materials at a time—such as gelatin and cellulose simultaneously. The temperature control module on the syringe may maintain unprinted gelatin at a high temperature (50° C.), and the gelatin may be rapidly cooled on a cooling panel after being printed, to achieve layer by layer printing.

In this prototype, the printer chassis may include a Velleman® 8400 control board using Marlin firmware. The printer may be controlled by Repetier-Host client software with the G-code generator Slic3r®.

In this prototype, to print edible films, two separate .stl files are created, one for the encapsulating substrate and the other for the support substrate. These two files may map to film materials (e.g., agar and cellulose) and G-code may be generated from these files using Slic3r®. Upon printing, the temperature of each syringe may be heated close to its material's glass transition temperature and extruded through a syringe at a target rate set by the firmware and G-code. The cooling system may rapidly cool each layer of substrate to a solid state upon deposition, thereby facilitating layering of both materials to form a thin film.

The prototype described in the preceding three paragraphs is a non-limiting example; this invention may be implemented in other ways.

### Computer-Aided Design of Shape Transformations

The inventors were confronted by technological problems, including:

(a) how to make a set of flat edible films transform into a set of different, curved 3D shapes, in such a way that which specific curved, 3D shape results from the shape transformation of a given film depends on parameters of the given film; and

(b) how to make a UI (user interface) interact with a human user, in such a way that (i) the user may, via the UI, select a target shape that is a curved, 3D shape and (ii) a computer calculates parameters of a flat edible film (such as orientation, thickness and density of fiber strips to be deposited on the film) that will cause the film, when it is hydrated, to transform into the target shape.

The inventors' solution to problem (a) includes the shape-transforming food described above.

The inventor's solution to problem (b) includes the computer functionality and UI described below.

In some implementations of this invention, a computer controls a user interface (UI). For example, in FIG. 22, computer 2250 controls UI 2252. The UI may interact with a human user, in an interactive process in which a shape-transforming, edible structure is designed. During this interactive process: (a) a user may, via the UI, enter a first input that selects a target shape that is a curved, 3D shape, and a computer may receive or access data that is indicative of this first input; (b) the computer may calculate one or more parameters of a flat edible structure (such as orientation, thickness, density or material composition of edible fibers that will be included in the structure), which parameters would, if the edible structure were hydrated, cause the edible structure to change from a flat shape into the target shape; (c) optionally, the user may, via the UI, enter a second input that adjusts the calculated parameters (e.g., adjusts the calculated orientation, thickness, density or material composition of the edible fibers), and the computer may receive or access data that is indicative of this second input; (d) the computer may calculate a simulation of a shape transformation of the edible structure that would occur, if the edible structure were to have the calculated (and if applicable, adjusted) parameters and were hydrated; (e) the computer may cause the UI to display to the user a preview of one or more simulated shapes of the edible structure that occur during the simulated transformation; (f) the user may, via the UI, enter a third input to approve or disapprove of the simulated shape(s) and the computer may receive or access data indicative of this third input; (g) if the third input indicates that the user approves the simulated shape(s), the computer may generate printer instructions (e.g., G-codes) and cause these instructions to be sent to a CNC printer; and (h) the CNC printer may, in accordance with these instructions, print all or part of the edible structure (e.g., may print only edible fibers or may print an entire edible structure including fibers and a gelatin film). In some cases, a machine-readable, non-transitory medium has instructions encoded thereon for enabling a computer to perform the computer functions described in the preceding sentence.

The UI (e.g., 2252 in FIG. 22) may include one or more input/output devices, including one or more of the following devices: visual display screen, touch screen, speaker, keyboard, mouse, haptic transducer, microphone, video camera, electrodes or other physiological sensors, or other devices for detecting gestures, identity or other attributes of a user. The UI may receive input from a user (or provide output to a user) via one or more of these input/output devices. The UI may comprise a graphical user interface.

In some implementations, a computer (e.g., 2250 in FIG. 22) may execute a software program for computer-assisted design of a shape-transforming food. Via the UI, the computer may interact with the user in a design process that includes the following steps. The user may select a target shape for a substrate film (e.g., a gelatin film). The computer may, based on the selected target shape, determine parameters of fiber strips (e.g., ethyl cellulose strips). The user may adjust the density, orientation, and thickness of the fiber strips (e.g., by dragging sliders). After parameters of the fiber strips are determined by the computer, the user may preview the transformation immediately. When the user is satisfied with the previewed transformation, the user may cause the computer to export G-codes for printing an edible structure that will undergo the previewed transformation when it hydrates or is exposed to a change in temperature.

In some implementations, a shape database is pre-computed. For example, the shape database may include pre-computed parameters of an edible film, or precomputed target shapes of an edible film, or a pre-computed mapping between parameters of an edible film and target shapes of the edible film. The pre-computed shape database may reduce computational load during operation of the UI or make it easier for the UI to display to the user a real-time preview of a simulated shape transformation. For example, in a prototype of this invention: (a) a shape database may be pre-calculated in Rhinoceros and Grasshopper™; and (b) by interpolating the pre-calculated shapes in the database, the UI may display a real-time preview of a simulated shape transformation.

Alternatively, or in addition, in some cases, a user may select, via the UI: (i) one or more target shapes of an edible film for which parameters of the film are not pre-computed or (ii) one or more parameters of an edible film for which the resulting shape are not pre-computed.

In some cases, software for a digital material design and simulation interface may be written in JavaScript®, Rhinoceros, and Grasshopper™

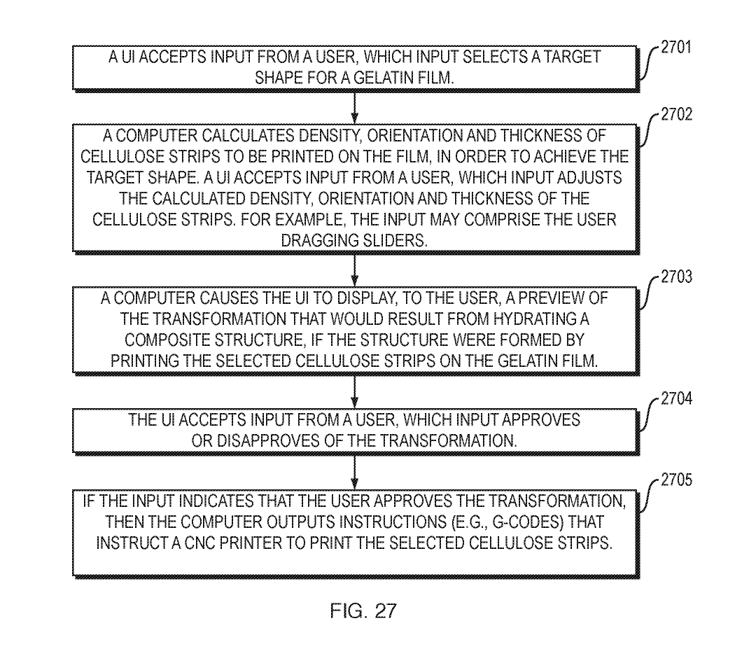

FIG. 27 is a flow chart for a method in which an interactive UI facilitates selection of parameters of cellulose strips (which affect bending behavior of an edible structure), in an illustrative implementation of this invention. The method shown in FIG. 27 includes the following steps: A UI accepts input from a user, which input selects a target shape for a gelatin film (Step 2701). A computer calculates density, orientation and thickness of cellulose strips to be printed on the film, in order to achieve the target shape. A UI accepts input from a user, which input adjusts the calculated density, orientation and thickness of the cellulose strips. For example, the input may comprise dragging sliders (Step 2702). A computer causes the UI to display, to the user, a preview of the transformation that would result from hydrating a composite structure, if the structure were formed by printing the selected cellulose strips on the gelatin film. (Step 2703). The UI accepts user input that approves or disapproves of the transformation (Step 2704). If the input indicates that the user approves the transformation, then the computer outputs instructions (e.g., G-codes) that instruct a CNC printer to print the selected cellulose strips (Step 2705). In FIG. 27, the computer accepts input from a user via a UI (user interface).

### Computers

In illustrative implementations of this invention, one or more computers (e.g., servers, network hosts, client computers, integrated circuits, microcontrollers, controllers, field-programmable-gate arrays, personal computers, digital computers, driver circuits, or analog computers) are programmed or specially adapted to perform one or more of the following tasks: (1) to control the operation of, or interface with, hardware components of a CNC printer, including any actuator, valve, pump, heating device, cooling device, or sensor of a CNC printer; (2) to calculate a shape transformation of an object based on one or more parameters, such as orientation, thickness, density or material properties of fiber strips or thickness, shape or material properties of a gelatin film; (3) to control one or more input/output devices to display or otherwise present a user interface in such a way that the interface accepts input from a human user and presents output to the user, including as steps in an interactive process to design a shape-transforming edible object; (4) to receive data from, control, or interface with one or more sensors; (5) to perform any other calculation, computation, program, algorithm, or computer function described or implied herein; (6) to receive signals indicative of human input; (7) to output signals for controlling transducers for outputting information in human perceivable format; (8) to process data, to perform computations, to execute any algorithm or software, and (9) to control the read or write of data to and from memory devices (items 1-9 of this sentence referred to herein as the “Computer Tasks”). The one or more computers (e.g., 2211, 2250) may be in any position or positions within or outside of the CNC printer. The one or more computers may communicate with each other or with other devices either: (a) wirelessly, (b) by wired connection, (c) by fiber-optic link, or (d) by a combination of wired, wireless or fiber optic links.

In exemplary implementations, one or more computers are programmed to perform any and all calculations, computations, programs, algorithms, computer functions and computer tasks described or implied herein. For example, in some cases: (a) a machine-accessible medium has instructions encoded thereon that specify steps in a software program; and (b) the computer accesses the instructions encoded on the machine-accessible medium, in order to determine steps to execute in the program. In exemplary implementations, the machine-accessible medium may comprise a tangible non-transitory medium. In some cases, the machine-accessible medium comprises (a) a memory unit or (b) an auxiliary memory storage device. For example, in some cases, a control unit in a computer fetches the instructions from memory.

In illustrative implementations, one or more computers execute programs according to instructions encoded in one or more tangible, non-transitory, computer-readable media. For example, in some cases, these instructions comprise instructions for a computer to perform any calculation, computation, program, algorithm, or computer function described or implied herein. For example, in some cases, instructions encoded in a tangible, non-transitory, computer-accessible medium comprise instructions for a computer to perform one or more of the Computer Tasks.

### Definitions

The terms “a” and “an”, when modifying a noun, do not imply that only one of the noun exists. For example, a statement that “an apple is hanging from a branch”: (i) does not imply that only one apple is hanging from the branch; (ii) is true if one apple is hanging from the branch; and (iii) is true if multiple apples are hanging from the branch.

To say that a computer “accepts” data means that the computer receives or accesses the data.

“CNC printer” means a device that deposits material in such a way that both position of deposition relative to a print bed and timing of deposition are controlled by a computer. Non-limiting examples of a “CNC printer” include a 3D printer, a FDM (fused deposition modeling) printer, a FFF (fused filament fabrication) printer, an SLA (stereolithography) printer, and an inkjet-head 3D printer.

The term “comprise” (and grammatical variations thereof) shall be construed as if followed by “without limitation”. If A comprises B, then A includes B and may include other things.

The term “computer” includes any computational device that performs logical and arithmetic operations. For example, in some cases, a “computer” comprises an electronic computational device, such as an integrated circuit, a microprocessor, a mobile computing device, a laptop computer, a tablet computer, a personal computer, or a mainframe computer. In some cases, a “computer” comprises: (a) a central processing unit, (b) an ALU (arithmetic logic unit), (c) a memory unit, and (d) a control unit that controls actions of other components of the computer so that encoded steps of a program are executed in a sequence. In some cases, a “computer” also includes peripheral units including an auxiliary memory storage device (e.g., a disk drive or flash memory), or includes signal processing circuitry. However, a human is not a “computer”, as that term is used herein.

“Defined Term” means a term or phrase that is set forth in quotation marks in this Definitions section.

Unless the context clearly indicates otherwise: (a) “density” means volumetric mass density; and (b) to say that A is “denser” than B means that A has a greater volumetric mass density than B. For example, to say that a top layer is “denser” than a bottom layer means that the volumetric mass density of the top layer is greater than that of the bottom layer.

For an event to occur “during” a time period, it is not necessary that the event occur throughout the entire time period. For example, an event that occurs during only a portion of a given time period occurs “during” the given time period.

The term “e.g.” means for example.

The fact that an “example” or multiple examples of something are given does not imply that they are the only instances of that thing. An example (or a group of examples) is merely a non-exhaustive and non-limiting illustration.

Unless the context clearly indicates otherwise: (1) a phrase that includes “a first” thing and “a second” thing does not imply an order of the two things (or that there are only two of the things); and (2) such a phrase is simply a way of identifying the two things, respectively, so that they each may be referred to later with specificity (e.g., by referring to “the first” thing and “the second” thing later). For example, unless the context clearly indicates otherwise, if an equation has a first term and a second term, then the equation may (or may not) have more than two terms, and the first term may occur before or after the second term in the equation. A phrase that includes a “third” thing, a “fourth” thing and so on shall be construed in like manner.

“Fluid” means a gas or a liquid.

“For instance” means for example.

To say a “given” X is simply a way of identifying the X, such that the X may be referred to later with specificity. To say a “given” X does not create any implication regarding X. For example, to say a “given” X does not create any implication that X is a gift, assumption, or known fact.

“Herein” means in this document, including text, specification, claims, abstract, and drawings.

To “hydrate” an object means to increase the amount of water in the object.

As used herein: (1) “implementation” means an implementation of this invention; (2) “embodiment” means an embodiment of this invention; (3) “case” means an implementation of this invention; and (4) “use scenario” means a use scenario of this invention.

The term “include” (and grammatical variations thereof) shall be construed as if followed by “without limitation”.

The term “or” is inclusive, not exclusive. For example, A or B is true if A is true, or B is true, or both A or B are true. Also, for example, a calculation of A or B means a calculation of A, or a calculation of B, or a calculation of A and B.

As used herein, the term “set” does not include a group with no elements. Mentioning a first set and a second set does not, in and of itself, create any implication regarding whether or not the first and second sets overlap (that is, intersect).

Unless the context clearly indicates otherwise, “some” means one or more.

As used herein, a “subset” of a set consists of less than all of the elements of the set.

The term “such as” means for example.

To say that a machine-readable medium is “transitory” means that the medium is a transitory signal, such as an electromagnetic wave.

“Volumetric mass density” of a substance means the mass of the substance per unit volume.

Except to the extent that the context clearly requires otherwise, if steps in a method are described herein, then the method includes variations in which: (1) steps in the method occur in any order or sequence, including any order or sequence different than that described; (2) any step or steps in the method occurs more than once; (3) any two steps occur the same number of times or a different number of times during the method; (4) any combination of steps in the method is done in parallel or serially; (5) any step in the method is performed iteratively; (6) a given step in the method is applied to the same thing each time that the given step occurs or is applied to different things each time that the given step occurs; (7) one or more steps occur simultaneously, or (8) the method includes other steps, in addition to the steps described herein.

Headings are included herein merely to facilitate a reader's navigation of this document. A heading for a section does not affect the meaning or scope of that section.

This Definitions section shall, in all cases, control over and override any other definition of the Defined Terms. The Applicant or Applicants are acting as his, her, its or their own lexicographer with respect to the Defined Terms. For example, the definitions of Defined Terms set forth in this Definitions section override common usage or any external dictionary. If a given term is explicitly or implicitly defined in this document, then that definition shall be controlling, and shall override any definition of the given term arising from any source (e.g., a dictionary or common usage) that is external to this document. If this document provides clarification regarding the meaning of a particular term, then that clarification shall, to the extent applicable, override any definition of the given term arising from any source (e.g., a dictionary or common usage) that is external to this document. To the extent that any term or phrase is defined or clarified herein, such definition or clarification applies to any grammatical variation of such term or phrase, taking into account the difference in grammatical form. For example, the grammatical variations include noun, verb, participle, adjective, and possessive forms, and different declensions, and different tenses.

### Variations

This invention may be implemented in many different ways. Here are some non-limiting examples:

In some implementations, this invention is an apparatus comprising: (a) a film, which film comprises gelatin and has a higher density of gelatin in a first layer of the film than in a second layer of the film; and (b) fiber strips, which strips are attached to the first layer and have an initial orientation, thickness and density; wherein the apparatus is edible and is configured to undergo a transformation when the apparatus hydrates, in such a way that (i) during the transformation, a surface of the gelatin changes shape from a flat surface to a curved, 3D surface, and (ii) the shape of the curved, 3D surface after the transformation depends, at least in part, on the initial orientation, thickness and density of the fiber strips. In some cases, the fiber strips comprise ethyl cellulose. In some cases, the film further comprises fruit punch, vegetable extract, fish or meat extract, or food dye. In some cases: (a) the apparatus includes a first gelatin material that has a first melting point and a second gelatin material that has a second melting point, the first melting point being lower than the second melting point; and (b) the apparatus is configured to come apart into separate pieces that comprise the second gelatin material, when the apparatus is heated to a temperature that is above the first melting point but below the second melting point. In some cases, the film further comprises an active functional reagent. In some cases, the apparatus is configured to at least partially wrap around another edible material during the transformation. In some cases, the transformation includes breaking the apparatus into separate pieces. In some cases, a texture of the apparatus changes during the transformation. In some cases, a first region of the film has a higher Bloom number than a second region of the film. In some cases, the transformation includes a change in shape that is triggered by a change in temperature. In some cases, the transformation includes dissolving a portion of the apparatus. In some cases: (a) a set of the fiber strips are parallel to each other; (b) fiber strips in the set have longitudinal axes; and (c) the transformation includes the apparatus bending in such a way that the longitudinal axes remain straight throughout the transformation. In some cases: (a) a set of the fiber strips are parallel to each other; (b) fiber strips in the set have longitudinal axes; and (c) the transformation includes the apparatus bending in such a way that the longitudinal axes become curved during the transformation. Each of the cases described above in this paragraph is an example of the apparatus described in the first sentence of this paragraph, and is also an example of an embodiment of this invention that may be combined with other embodiments of this invention.

In some implementations, this invention is a set of apparatuses, wherein: (a) each respective apparatus, in the set of apparatuses, is edible and comprises (i) a film, which film comprises gelatin and has a higher density of gelatin in a first layer of the film than in a second layer of the film; and (ii) fiber strips, which strips are attached to the first layer and have an initial orientation, thickness and density; (b) a first apparatus, in the set of apparatuses, is configured to undergo a first transformation when the first apparatus hydrates; (c) a second apparatus, in the set of apparatuses, is configured to undergo a second transformation when the second apparatus hydrates; and (d) a geometric shape of the first apparatus that occurs during the first transformation is different than each geometric shape of the second apparatus that occurs during the second transformation. In some cases, the first transformation includes breaking the first apparatus into separate pieces. In some cases, initial orientation, thickness or density of fiber strips of the first apparatus is different than initial orientation, thickness or density of fiber strips in the second apparatus. In some cases, the fiber strips comprise ethyl cellulose. Each of the cases described above in this paragraph is an example of the set of apparatuses described in the first sentence of this paragraph, and is also an example of an embodiment of this invention that may be combined with other embodiments of this invention.

In some implementations, this invention is a method comprising: (a) fabricating a film, in such a way that (i) the film comprises gelatin and (ii) density of the gelatin is greater in a first layer of the film than in a second layer of the film; (b) depositing edible fibers onto the first layer of the film; and (c) hydrating the film; wherein, during the hydrating, the fibers constrain swelling of the film in such a way that the film changes from a flat shape to a curved 3D shape. In some cases, the edible fibers comprise ethyl cellulose. In some cases: (a) the edible fibers are deposited in strips that comprise a mixture of ethyl cellulose and ethanol; and (b) the ethanol evaporates after the depositing and before the hydrating. Each of the cases described above in this paragraph is an example of the method described in the first sentence of this paragraph, and is also an example of an embodiment of this invention that may be combined with other embodiments of this invention.

In some implementations, this invention is a method comprising: (a) accepting, via a user interface, data indicative of an input by a user, which input comprises selecting a target shape; (b) calculating orientation, thickness or density of fiber strips; (c) outputting instructions for a CNC printer to deposit the fiber strips on a first layer of a film, which instructions specify the orientation, thickness or density of the fiber strips; and (d) depositing the fiber strips on the first layer of the film, in accordance with the instructions; wherein (i) the accepting, calculating and outputting are performed by one or more computers, (ii) the depositing is performed by the CNC printer, and (iii) during the depositing (A) the film comprises gelatin and (B) density of gelatin of the film is greater at the first layer of the film than in another region of the film. In some cases: (a) the method further comprises hydrating the film; and (b) during the hydrating, the fiber strips constrain swelling of the film in such a way that the film changes in shape from a flat shape into the target shape. Each case described above in this paragraph is an example of the method described in the first sentence of this paragraph, and is also an example of an embodiment of this invention that may be combined with other embodiments of this invention.

In some implementations, this invention is a method comprising: (a) accepting, via a user interface, data indicative of a first input by a user, which first input comprises selecting a target shape; (b) calculating a first computer simulation to determine orientation, thickness or density of fiber strips that, in the first computer simulation, are attached to a first layer of a film and constrain water-induced swelling of the film in such a way that the film changes in shape from a flat shape into the target shape; (c) accepting, via the user interface, data indicative of a second input by the user, which second input specifies an adjusted orientation, thickness or density of the fiber strips; (d) calculating a second computer simulation to determine a shape transformation of the film, which transformation would occur if the fiber strips with the adjusted orientation, thickness or density were attached to the first layer of the film and the film were hydrated; (e) outputting instructions for a user interface to display to the human user a preview of the shape transformation; (f) accepting, via the user interface, data indicative of a third input by the human user, which third input approves or disapproves of the shape transformation; (g) if the third input approves of the shape transformation, outputting instructions that instruct a CNC printer to deposit, on the first layer of the film, physical fiber strips that have the adjusted orientation, thickness or density; and (h) depositing the physical fiber strips on the first layer of the film, in accordance with the instructions; wherein (1) steps (a), (b), (c), (d), (e), (f) and (g) are performed by one or more computers, (2) step (h) is performed by the CNC printer, (3) during the depositing, the film comprises gelatin, and (4) during the depositing, density of the gelatin is greater in the first layer of the film than in another region of the film.

Each description herein of any method or apparatus of this invention describes a non-limiting example of this invention. This invention is not limited to those examples, and may be implemented in other ways.

Each description herein of any implementation, embodiment or case of this invention (or any use scenario for this invention) describes a non-limiting example of this invention. This invention is not limited to those examples, and may be implemented in other ways.

Each Figure that illustrates any feature of this invention shows a non-limiting example of this invention. This invention is not limited to those examples, and may be implemented in other ways.

The Provisional Application does not limit the scope of this invention. The Provisional Application describes non-limiting examples of this invention, which examples are in addition to—and not in limitation of—the implementations of this invention that are described in the main part of this document. For example, if any feature described in the Provisional Application is different from, or in addition to, the features described in the main part of this document, this additional or different feature of the Provisional Application does not limit any implementation of this invention described in the main part of this document, but instead merely describes another example of this invention. As used herein, the “main part of this document” means this entire document (including any drawings listed in the Brief Description of Drawings above and any software file listed in the Computer Program Listing section above), except that the “main part of this document” does not include any document that is incorporated by reference herein.

The above description (including without limitation any attached drawings and figures) describes illustrative implementations of the invention. However, the invention may be implemented in other ways. The methods and apparatus which are described herein are merely illustrative applications of the principles of the invention. Other arrangements, methods, modifications, and substitutions by one of ordinary skill in the art are therefore also within the scope of the present invention. Numerous modifications may be made by those skilled in the art without departing from the scope of the invention. Also, this invention includes without limitation each combination and permutation of one or more of the implementations (including hardware, hardware components, methods, processes, steps, software, algorithms, features, or technology) that are described or incorporated by reference herein.

What is claimed is:

1. An apparatus comprising:
(a) a film, which film comprises gelatin and has a higher density of gelatin in a first layer of the film than in a second layer of the film; and
(b) fiber strips, which strips are attached to the first layer and have an initial orientation, thickness and density;
wherein the apparatus is edible and is configured to undergo a transformation when the apparatus hydrates, in such a way that
(i) during the transformation, a surface of the gelatin changes shape from a flat surface to a curved, 3D surface, and
(ii) the shape of the curved, 3D surface after the transformation depends, at least in part, on the initial orientation, thickness and density of the fiber strips.

2. The apparatus of claim 1, wherein the fiber strips comprise ethyl cellulose.

3. The apparatus of clam 1, wherein the film further comprises fruit punch, vegetable extract, fish extract, meat extract, or food dye.

4. The apparatus of claim 1, wherein:
(a) the apparatus includes a first gelatin material that has a first melting point and a second gelatin material that has a second melting point, the first melting point being lower than the second melting point; and
(b) the apparatus is configured to come apart into separate pieces that comprise the second gelatin material, when the apparatus is heated to a temperature that is above the first melting point but below the second melting point.

5. The apparatus of claim 1, wherein the film further comprises an active functional reagent.

6. The apparatus of claim 1, wherein the apparatus is configured to at least partially wrap around another edible material during the transformation.

7. The apparatus of claim 1, wherein the transformation includes breaking the apparatus into separate pieces.

8. The apparatus of claim 1, wherein a texture of the apparatus changes during the transformation.

9. The apparatus of claim 1, wherein a first region of the film has a higher Bloom number than a second region of the film.

10. The apparatus of claim 1, wherein the transformation includes a change in shape that is triggered by a change in temperature.

11. The apparatus of claim 10, where the transformation includes dissolving a portion of the apparatus.

12. The apparatus of claim 1, wherein:
(a) a set of the fiber strips are parallel to each other;
(b) fiber strips in the set have longitudinal axes; and
(c) the transformation includes the apparatus bending in such a way that the longitudinal axes remain straight throughout the transformation.

13. The apparatus of claim 1, wherein:
(a) a set of the fiber strips are parallel to each other;
(b) fiber strips in the set have longitudinal axes; and
(c) the transformation includes the apparatus bending in such a way that the longitudinal axes become curved during the transformation.

14. A set of apparatuses, wherein:
(a) each respective apparatus, in the set of apparatuses, is edible and comprises
(i) a film, which film comprises gelatin and has a higher density of gelatin in a first layer of the film than in a second layer of the film; and
(ii) fiber strips, which strips are attached to the first layer and have an initial orientation, thickness and density;
(b) a first apparatus, in the set of apparatuses, is configured to undergo a first transformation when the first apparatus hydrates;
(c) a second apparatus, in the set of apparatuses, is configured to undergo a second transformation when the second apparatus hydrates; and
(d) a geometric shape of the first apparatus that occurs during the first transformation is different than each geometric shape of the second apparatus that occurs during the second transformation.

15. The set of apparatuses of claim 14, wherein the first transformation includes breaking the first apparatus into separate pieces.

16. The set of apparatuses of claim 14, wherein initial orientation, thickness or density of fiber strips of the first apparatus is different than initial orientation, thickness or density of fiber strips in the second apparatus.

17. The set of apparatuses of claim 14, wherein the fiber strips comprise ethyl cellulose.

18. A method comprising:
(a) fabricating a film, in such a way that (i) the film comprises gelatin and (ii) density of the gelatin is greater in a first layer of the film than in a second layer of the film;
(b) depositing edible fibers onto the first layer of the film; and
(c) hydrating the film;
wherein, during the hydrating, the fibers constrain swelling of the film in such a way that the film changes from a flat shape to a curved 3D shape.

19. The method of claim 18, wherein the edible fibers comprise ethyl cellulose.

20. The method of claim 18, wherein:
(a) the edible fibers are deposited in strips that comprise a mixture of ethyl cellulose and ethanol; and
(b) the ethanol evaporates after the depositing and before the hydrating.
